(19) United States
(12) Patent Application Publication
(10) Pub. No.: US 2009/0096372 A1
(43) Pub. Date: Apr. 16, 2009

(54) Device for making objects visible under low or zero environmental illumination conditions

(76) Inventors: Valeria Menotti, Milano (IT); Alessandro Colombini, Milano (IT)

Correspondence Address: HEDMAN & COSTIGAN P.C., 1185 AVENUE OF THE AMERICAS, NEW YORK, NY, 10036, US

(21) Appl. No.: 12/286,038

(22) Filed: Sep. 26, 2008

(30) Foreign Application Priority Data
Oct. 16, 2007 (IT) MI2007A 001998

(51) Int. Cl. H01J 1/62

(52) U.S. Cl. 313/506

(57) ABSTRACT

A device for making objects visible under low or zero environmental illumination conditions comprises a layer of luminescent paint applied to an exposed to the view surface of an object and an optically transparent material protective layer applied to the luminescent paint layer.

### BACKGROUND OF THE INVENTION

The present invention relates to a device for making objects visible under low or zero environmental illumination conditions.

A problem frequently encountered in a domestic environment, but also in a hotel room or other sleeping environments, is the difficulty of properly locating objects or articles, without switching on the light and disturbing the other persons which can be present in the environment.

Moreover, is very difficult to move through a room, in particular if it is not well known, without switching on the light, in the absence of visible references, such as doors or other fixed objects.

### SUMMARY OF THE INVENTION

The aim of the present invention is to provide a device and a method for solving the above mentioned problem, allowing to make an object or article visible under low or zero environmental illumination conditions.

Within the scope of the above mentioned aim, a main object of the invention is to provide such a device and method which can be applied to common use articles.

Yet another object of the invention is to provide such a device and method providing visibility characteristics of high duration and which are stable in the time.

Another object of the present invention is to provide such a device which, owing to its specifically construction features, is very reliable and safe in operation.

Yet another object of the present invention is to provide such a device which can be easily made and which, moreover, is very competitive from a mere economic standpoint.

According to one aspect of the present invention, the above mentioned aim and objects, as well as yet other objects, which will become more apparent hereinafter, are achieved by a device for making objects visible under low or zero environmental illumination conditions, characterized in that said device comprises a luminescent paint layer applied to an exposed to view surface of an object and an optically transparent material protective layer applied to said luminescent paint layer.

Said aim and objects are moreover achieved by a method for making objects visible under low or zero environmental illumination conditions, characterized in that said method comprises applying a luminescent paint layer to an exposed to view surface of an object and further applying an optically transparent material protective layer to said luminescent paint layer.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative but not limitative, example, in the accompanying drawings, where:

FIG. 1 schematically shows a domestic and/or personally use object or article such as an eyeglass casing having a luminescent surface, according to the present invention;

FIG. 2 schematically shows a keyholder, including a luminescent surface, according to the present invention;

FIG. 3 schematically shows a table or alarm clock including a luminescent surface;

FIGS. 4 and 5 schematically show two containers provided with a luminescent surface, according to the present invention; and

FIG. 6 shows a nightly article or clothing and slippers including a luminescent surface according to the present invention.

### DESCRIPTION OF THE PREFERRED EMBODIMENTS

With reference to the number references of the above mentioned figures, the device according to the present invention comprises a luminescent paint layer applied to an exposed to view surface of an object or article which can be made of different materials such as wood, plastic, metal, fabric and the like materials.

The luminescent paint is preferably constituted by water soluble acrylic dyes, resistant to atmospheric agents and having fluorescent characteristics.

It is also possible to use a luminescent acrylic paint adapted to provide a phosphorescent effect.

To protect the luminescent paint layer and providing it with time stable optical characteristics, an optically transparent protective material layer is moreover provided.

Said protective layer is advantageously constituted by a metacrylate polymer for example of a type commercially known with the trademarks “Plexiglas”, “Perspex”, and the like.

The accompanying figures show some non limiting examples of possible applications of the device according to the present invention.

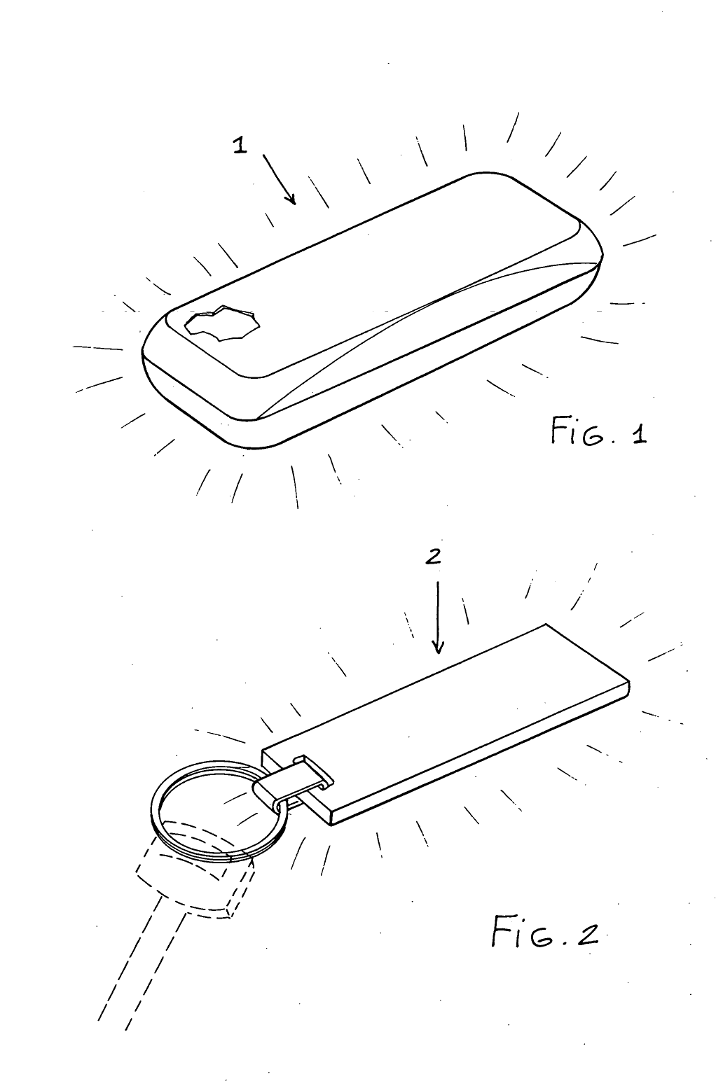

In particular, FIG. 1 schematically shows a first exemplary domestic and/or personal use object or article, comprising an eyeglass casing, generally indicated by the reference number 1, including a luminescent surface.

FIG. 2 shows another exemplary object or article comprising a keyholder 2 including a luminescent surface according to the present invention.

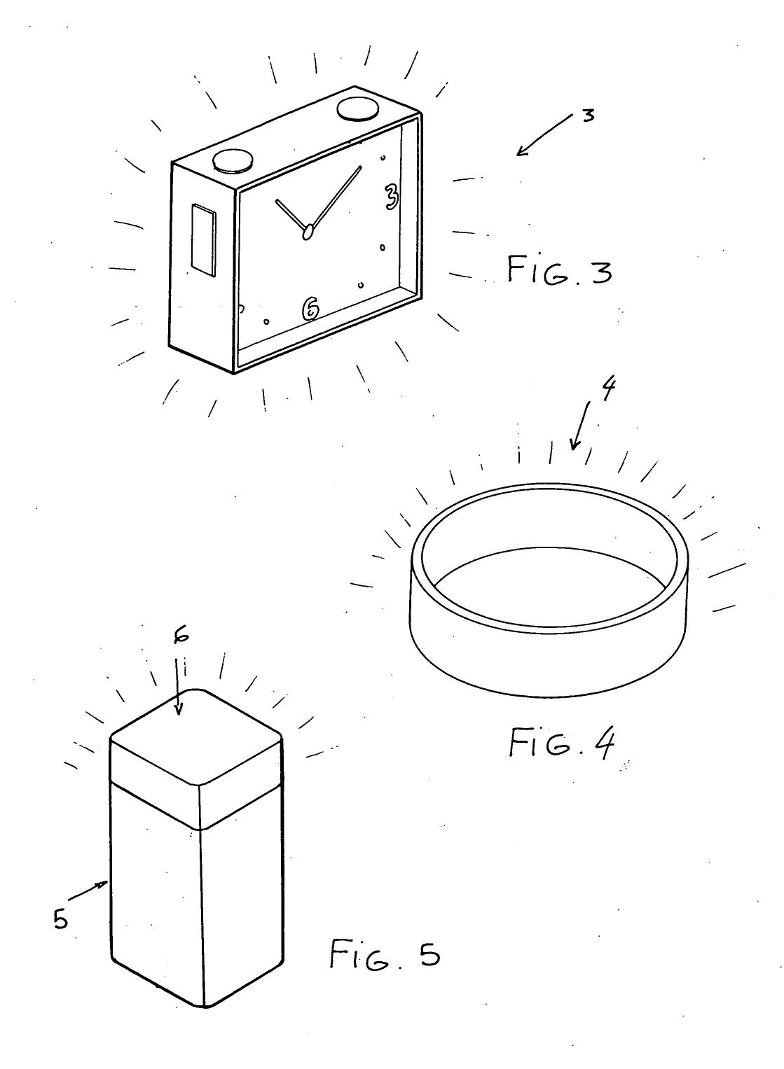

FIG. 3 shows an alarm clock, generally indicated by the reference number 3, having a surface which is at least partially made luminescent by a method according to the present invention.

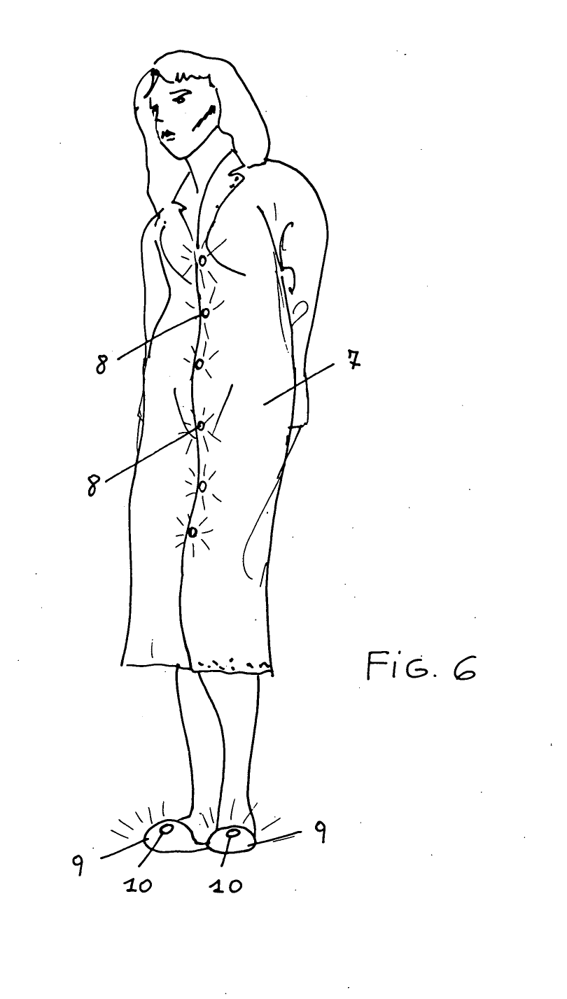

FIGS. 4 and 5 schematically show two containers, respectively indicated by the reference numbers 4 and 5, in which all the outer surface, or a part thereof, has been made luminescent.

In the case of the container 5, only its plug 6, for example, is luminescent.

FIG. 6 shows a user wearing a nightly article of clothing 7, including luminescent buttons 8 and slippers 9 also including luminescent elements.

In this connection it should be pointed out that the device according to the present invention can also be applied to any other articles such as door handles.

An application of the inventive device to a door handle is very advantageous since it will allow to properly locate the door in a room, while allowing the user to easily orient in the dark even in unknown environment.

The inventive device can also be advantageously applied to a water ring cover, thereby allowing the user to perceive the position of the water in the bath room, even without switching the light on.

It has been found that the invention fully achieves the intended aim and objects.

In fact, the invention provides a device allowing to make objects or article to which the device is applied visible even in a dark environment.

The present invention, in particular, can also be applied to make visible a signal and safety marks in a domestic, ship building, industrial, hospital, naval and public place applications.

The device and method according to the present invention are very inexpensive and can be applied to several different objects or articles.

In practicing the invention, the used materials, as well as the contingent size and shapes, can be any, depending on requirements.

1. A device for making objects visible under low or zero environmental illumination conditions, characterized in that said device comprises a luminescent paint layer applied to an exposed to view surface of an object and an optically transparent material protective layer applied to said luminescent paint layer.

2. A device according to claim 1, characterized in that said luminescent paint is selected from atmospheric agent resistant water soluble acrylic dyes, having fluorescent properties.

3. A device according to claim 1, characterized in that said luminescent paint is a luminescent acrylic paint, adapted to provide a phosphorescent effect.

4. A device according to claim 1, characterized in that said optically transparent material protective layer comprises a metacrylate polymer of a type commercially known with the trademarks “Plexiglas”, “Perspex”, and the like.

5. A method for making objects visible under low or zero environmental illumination conditions, characterized in that said method comprises the steps of applying a luminescent paint layer to an exposed to view surface of an object and further applying an optically transparent material protective layer to said luminescent paint layer.

6. A device as defined in claim 1 wherein said device is applied to a personal or domestic use object, characterized in that said object is at least partially covered by a luminescent paint layer and an optically transparent material protective layer applied to said luminescent paint layer.

7. A device as defined in claim 1 wherein said device is applied to an eyeglass casing, characterized in that said eyeglass casing is at least partially coated by a luminescent paint layer and an optically transparent material protective layer applied to said luminescent paint layer.

8. A device as defined in claim 1 wherein said device is applied to a keyholder, characterized in that said keyholder is at least partially coated by a luminescent paint layer and an optically transparent material protective layer applied to said luminescent paint layer.

9. A device as defined in claim 1 wherein said device is applied to an alarm clock, characterized in that said alarm clock is at least partially covered by a luminescent paint layer and an optically transparent material protective layer applied to said luminescent paint layer.

10. A device as defined in claim 1 wherein said device is applied to a container, characterized in that said container is at least partially coated by a luminescent paint layer and an optically transparent material protective layer, applied to said luminescent paint layer.

11. A device as defined in claim 1 wherein said device is applied to a article of clothing, characterized in that said article of clothing comprises a portion, such as a button thereof, at least partially coated by a luminescent paint layer and an optically transparent material protective layer applied to said luminescent paint layer.

12. A device as defined in claim 1 wherein said device is applied to a door handle, characterized in that said door handle is at least partially coated by a luminescent paint layer and an optically transparent material protective layer, applied to said luminescent paint layer.

13. A device as defined in claim 1 wherein said device is applied to a ring shaped cover, characterized in that said ring shaped cover is at least partially coated by a luminescent paint layer and an optically transparent material protective layer applied to said luminescent paint layer.

14. A device, according to claim 1, characterized in that said device is used to make visible signals and safety indicating marks for domestic, ship building, industrial, hospital, naval and public place applications.
